(19) United States
(12) Patent Application Publication
(10) Pub. No.: US 2019/0164116 A1
(43) Pub. Date: May 30, 2019

(54) SYSTEM FOR CAPTURING VERIFIED CONSUMPTION PROFILES FOR FOOD ITEMS

(71) Applicant: Perfect Company, Inc., Vancouver, WA (US)

(72) Inventors: Michael Wayne Wallace, Vancouver, WA (US); Daniel Short, Camas, WA (US)

(73) Assignee: Perfect Company, Inc.

(21) Appl. No.: 15/827,874

(22) Filed: Nov. 30, 2017

(51) Int. Cl. G06Q 10/08; G06K 9/00

(52) U.S. Cl. CPC G06Q 10/087; G06T 2207/30128; G06K 9/00624

(57) ABSTRACT

A consumption capture system is able to detect and verify point of consumption data for acquired goods, and generate consumption profiles for individual or groups of goods. A consumption profile may describe information associated with consumption events that have been corroborated by one or more of recipe information, user input, sensor data, account information, etc. The consumption capture system may verify the occurrence of a consumption event using data from sensors incorporated into kitchen appliances, storage pantries, etc., and may use the data and acquire other data to build a set of information that describes details about the consumption event. In this way, the consumption profiles comprise verified insight into how individual goods are consumed once they are obtained by a customer. Such verified consumption histories allow both customers and merchants to gain insight into the consumption histories of goods.

### BACKGROUND

Service providers meticulously acquire information about the services and the goods they provide. This information enables them to optimize the services they provide, which both improves their efficiency and maximizes customer experience/satisfaction. For example, by knowing the amount of goods that are sold and the locations at which the sales occur, a service provider can predict the times and locations that the future goods will be purchased. The service provider can then use this information to design its distribution schedules to ensure that each location always has enough inventory to support customer demand.

Unfortunately, current technologies only allow services to effectively capture sales information at the time a good is purchased. That is, current technologies are only able to effectively determine information about goods up to the time they are obtained by the consumer, and cannot capture reliable and accurate information about how those goods are consumed in the households of the consumer. If service providers had access to this information, they would be able to better tailor their services to accommodate how their goods/services are actually used by their consumers. For at least these reasons, current service providers need systems to be designed to track and generate accurate and reliable consumption data for goods and services acquired by consumers.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative environment for generating and updating consumption profiles for food items consumed by a user.

FIG. 2 is an illustrative computing architecture of a computing device configured to generate and manage a consumption profiles for food items consumed by a user.

FIG. 3 is a flow diagram of an illustrative process for generating and managing a consumption profile for a food item.

FIG. 4 is an example illustration of a graphical user interface that visually presents a consumption profile for a fully consumed food item.

FIG. 5 is an example illustration a graphical user interface that visually presents a consumption profile for a partially consumed food item.

FIG. 6 is a flow diagram of illustrative process for using verification data from an applicant to verify consumption events, and generating and managing consumption profiles to reflect the verified consumption events.

FIGS. 7A and 7B are example illustrations of a user computing device and an appliance configured to capture verification data to corroborate consumption events.

### DETAILED DESCRIPTION

This disclosure is generally directed to a consumption capture system that is able detect and verify point of consumption data for acquired goods, and generate consumption profiles for individual or groups of goods. A good may include any item of food or drink, including raw ingredients (e.g., eggs, butter, oats, milk, olive oil, carrots, gin, chicken breast, etc.), and prepared ingredients (e.g., ice cream, butter, pasta sauce, sangria, potato salad, etc.). Consumption data for a good may identify the good; an amount of the good consumed; one or more times related to the consumption of the good (e.g., times associated with the consumption capture system detection of events associated with consumption of the good); nutritional information for the consumed good; a brand or other identifier associated with the good; a user identifier associated with the individual consuming the good; or an indication that the consumption of the good was verified by information from an appliance, sensor, or similar.

A consumption profile for a good or group of goods that is generated by the consumption capture system may include information associated with one or more good or group of goods, such as a name of the good, size of the good, statistics describing individual consumption events (instances of usage of the good captured by the consumption capture system), times of consumption events, schedule of consumption of a good, amount of the good consumed before expiration, and similar.

A consumption capture system may include one or more electronic consumption tracking devices for tracking goods that a user consumes or otherwise has on hand, such as smart storage spaces, appliances, computing devices associated with a consumption capture application, etc. Smart storage spaces may include cabinets, shelving, or other storage resources that include one or more sensors for monitoring food items contained therein. An appliance may include a scale, oven, blender, mixer, refrigerator, food thermometer, or other type of tool used to store and/or prepare food. An appliance may include one or more sensors that allow the appliance to capture information relating to a good being consumed. For example, a blender may include a sensor that detects a mass of a good that is placed in a blending container, thus allowing the blender to detect an amount of a good that is consumed via the blender when it is used. In some embodiments, a computing device may be integrated into one or more of the appliances. For example, a kitchen appliance (i.e., refrigerator, blender, oven, etc.) may include a memory and processors that enable the kitchen appliance to present a graphical smart pantry interface on a display.

A consumption capture application may include software that enables a computing device to maintain and update consumption profiles for individual or groups of goods. The consumption capture application may be run on a computing device associated with a user, such as a smartphone, tablet, personal computer, laptop, voice controlled computing device, server system, or other computing system that is able to execute and/or present one or more functionalities associated with the consumption capture application. In some embodiments, the consumption capture application may use consumption data to generate and/or update consumption profiles for a good associated with the consumption data. For example, the consumption data may be manually entered into the consumption capture application, may be acquired by scanning food items (e.g., bar code scan, QR code scan, RFID tag scan, photograph of food item packaging, etc.), photographing or scanning receipts of food items purchased from a vendor, reading sensor data from one or more sensors in a smart storage space and/or appliance, or a combination of such actions.

Alternatively or in addition, a consumption capture application may generate consumption profiles using information associated with one or more user accounts, such as grocery store membership accounts, an account with a shopping list application, accounts associated with electronic shopping services, credit card accounts, or other user accounts that may provide information relating to food items purchased or otherwise acquired by a user. For example, in response to a grocery store membership account indicating that a user has purchased a gallon of milk, a consumption capture application may generate a consumption profile for the milk that identifies information about the milk purchased by the user, such as an amount, a date of purchase, an expiration date, a brand, a variety, etc.

In some embodiments, a consumption capture application may build or update the one or more consumption profiles using information associated with consumption by the user. For example, a consumption capture application may generate or modify consumption profiles that correspond to ingredients of a recipe that a user has indicated that he or she made. Alternatively or in addition, a consumption capture application may build or otherwise update a consumption profile using point of consumption (POC) data that verifies the consumption of a good based on recipe data and corresponding sensor data. For example, a computing device may include a recipe application that provides one or more recipe functionalities associated with a recipe. The recipe may include a set of instructions for preparing a particular food or drink item. The recipe steps may include one or more actions performed during preparation of a recipe (e.g., adding an ingredient to a container, turning on a blender, preheating an oven, etc.). The recipe functionalities may include a graphical recipe interface, a series of visual and/or audio signals for guiding a user through a recipe, or a combination thereof. For example, the application may present a graphical recipe interface that includes a recipe step that a certain amount of an ingredient is to be added to a container that is on a kitchen scale.

An appliance associated with a recipe application may include one or more components that detect and provide information associated with recipe steps to the recipe application. For example, the recipe application may direct a user to place a container on a kitchen scale, and to add a first ingredient to the container. The kitchen scale may then detect that the container has been placed onto the scale, and/or detect a change in the mass of the container. This may involve a first detection that the mass of the container is increasing, and a second detection that the mass of the container has become stable (i.e., the mass has not changed more than a threshold amount for a period of time). The kitchen scale may then provide sensor data associated with the addition of the ingredient to the recipe application and/or the consumption capture application via a wired or wireless connection.

A recipe application and/or a consumption capture application may receive sensor data, verify that the information matches expected information for an ingredient of a recipe, and then generate verified POC data associated with the ingredient. In some embodiments, generating the POC data may include causing the consumption capture application to generate a consumption profile for a good that reflects information that describes characteristics of a corresponding good, and/or one or more consumption events where the consumption capture system has generated POC data associated with the corresponding good. For example, based on a recipe application verifying that a user has added 2 cups of flour to a recipe, a consumption capture application may update a consumption profile associated with the flour to reflect the consumption event (e.g., a time that the event occurred, an amount of flour consumed, the use of the flour, etc.).

Alternatively or in addition, a consumption capture application may update a consumption profile to reflect verification of a user adding an ingredient. For example, based on a recipe application verifying that a user has added two eggs to a container, a consumption capture application may update a consumption profile associated with the eggs to include information reflecting the consumption event, such as the number of eggs added, the time/date they were added, the recipe for which they were added, etc. In some embodiments, the recipe application and the consumption capture application may be a single application.

In some embodiments, a consumption capture application may be able to provide a graphical interface that allows a user to review one or more consumption profiles, and/or provide recommendations or notifications to the user based on the consumption profiles. For example, a consumption capture application may provide a user interface that includes statistical and/or graphical representations. The consumption capture application may also provide recommendations of one or more recipes that a user can make with food items in a smart pantry, and/or that allow a user to use up an expiring food. When a user has indicated that they want to make a recipe that includes food items that are not included in the smart pantry, the consumption capture application may also generate a shopping list and/or add the needed items to an existing shopping list.

The techniques, apparatuses, and systems described herein may be implemented in a number of ways. Example implementations are provided below with reference to the following figures.

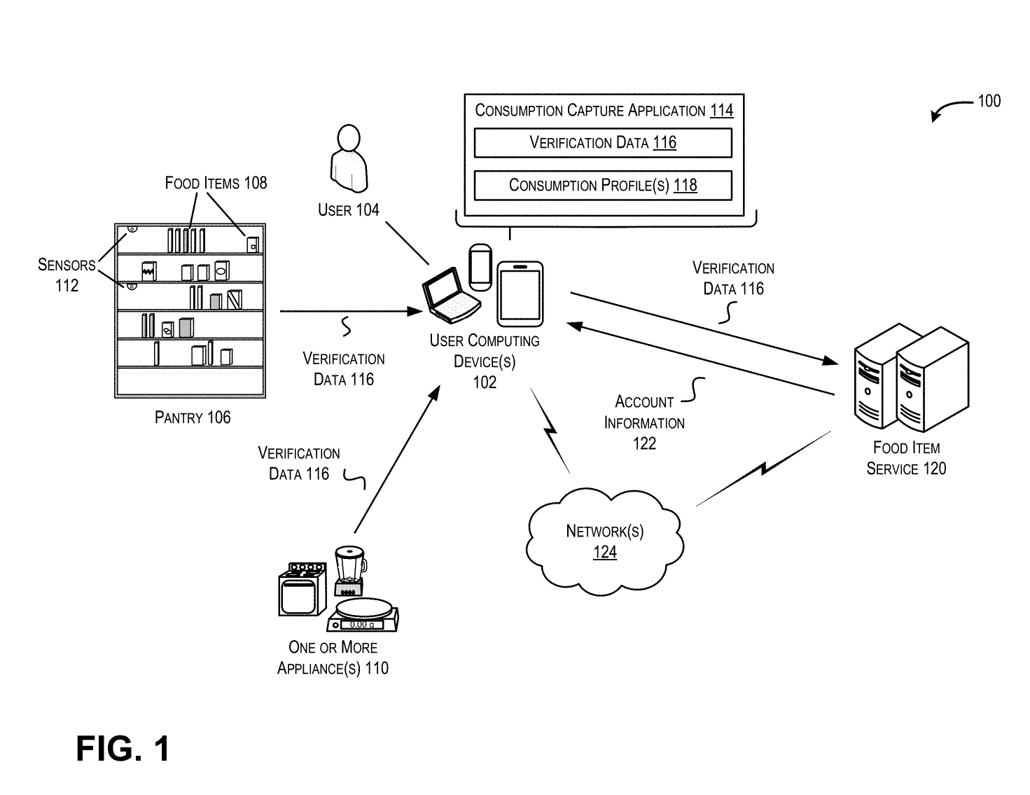

FIG. 1 is a schematic diagram of an illustrative environment 100 for generating and updating consumption profiles for food items 108 consumed by a user 104. The environment 100 includes the user computing device 102, and user 104 associated with user computing device 102. User computing device 102 may include any type of device (e.g., a laptop computer, personal computer, voice controlled computing device a tablet device, a mobile telephone, etc.). Any such device may include one or more processor(s), computer-readable media, speakers, a display, etc. Environment 100 further includes one or more electronic consumption tracking devices for tracking the food items 108 that user 104 consumes or otherwise has on hand, such as smart storage spaces (e.g., pantry 106), appliances (e.g., appliances 110), computing devices associated with a consumption capture application (e.g., user computing device 102, other computing devices), etc.

Pantry 106 may include one or more storage spaces for storing food items 108 (e.g., cabinets, shelving, refrigerators, freezers, or other storage resources). Food items 108 may include any item of food or drink, including raw ingredients (e.g., eggs, butter, oats, milk, olive oil, carrots, gin, chicken breast, etc.), and prepared ingredients (e.g., ice cream, butter, pasta sauce, sangria, potato salad, etc.). In some embodiments, one or more of the storage spaces of pantry 106 may include one or more sensors 112 for monitoring food items 108 contained therein. For example, pantry 106 may include one or more sensors that can scan or otherwise detect food items 108 stored within it, detect an amount of mass associated with one or more food items 108, etc.

Appliance 110 may include a scale, oven, blender, mixer, refrigerator, food thermometer, or other type of tool used to store and/or prepare food. In some embodiments, appliance 110 may include one or more sensors that allow the appliance 110 to capture information relating to a food item 108 being consumed by user 104. For example, a blender may include a sensor that detects a mass of a food item 108 that is placed in a blending container. In this way, the blender may detect an amount of the food item 108 that is being consumed. In some embodiments, a computing device 102 may be integrated into one or more of the appliances 110. For example, a kitchen appliance (i.e., refrigerator, blender, oven, etc.) may include a memory and processors that enable the kitchen appliance to present a graphical smart pantry interface on a display.

FIG. 1 further depicts user computing devices 102 as including consumption capture application 114. Consumption capture application 114 may enable one or more of the computing devices 102 to utilize verification data 116 to generate and maintain consumption profiles 118 of food items 108. A consumption profile 118 may be a collection of data associated with one or more food items 108, which may include information such as the name of the food item 108, size of the food item 108, statistics describing individual consumption events associated with the food item 108 (i.e., instances of usage of the food item 108 captured by the consumption capture system), times of consumption events, timetable of consumption of a food item 108, amount of the food item 108 consumed before expiration, etc. In some embodiments, a consumption profile 118 may correspond to an individual data file. Alternatively, more than one consumption profiles 118 may be stored within a single data file. For example, user computing device 102 may store in a memory a data file that contains consumption information for user 104, including the food items 108 stored in the user's pantry 106, a log of consumption events for individual food items 108, a current status of individual food items 108 in the pantry (i.e., amount left, time to expiration, etc.), and/or other information.

Verification data 116 may be information that evidences one or more of an acquisition of a food item 108 and/or a consumption event where one or more food items 108 are being consumed. Verification data 116 may be provided to the user computing device by one or more of pantry 106, appliances 110, and food item service 120. Where verification data 116 is transmitted to the user computing device 102 from the pantry 106, the verification data 116 may correspond to sensor data from one or more sensors located within pantry 106. For example, based on sensor 112 in pantry 106 detecting an RFID signal associated with a 18 oz. bottle of Organic Flavor brand vanilla extract, verification data 116 that indicates that user 104 has acquired an 18 oz. bottle of Organic Flavor brand vanilla extract may be transmitted to user computing device 102. In another example, sensor 112 may detect that the mass of a bottle of Organic Flavor brand vanilla extract has decreased by 2 oz., and verification data 116 may be transmitted to user computing device 102 that indicates that user 104 has consumed 2 oz. of Organic Flavor brand vanilla extract.

In some embodiments, verification data 116 may correspond to sensor data from one or more sensors located within appliance 110. For example, a blender may be capable of sensing when a container is placed on the blender, or detect a change in mass that occurs when a user 104 adds an amount of a food item 108 to the blending container, and may transmit verification data 116 to user computing device 102 that corresponds to the detected amount of the food item 108 having been consumed. In some embodiments, verification data 116 may be transmitted to user computing device 102 from one or more of pantry 106 and appliance 110 via a wired or wireless communications means.

The consumption capture application 114 may also acquire verification data 116 via account information 122 associated with one or more user accounts. For example, user computing device 102 may provide to food item service 120 account information 122, such as identifiers, user names, passwords, etc. associated with grocery store membership accounts, an account for a shopping list application, accounts associated with electronic shopping services, credit card accounts, or other user accounts that may provide information relating to food items 108 purchased or otherwise acquired by an individual. The consumption capture application 114 may then receive verification data 116 from food item service 120 based on the account information 122.

Food item service 120 may be any entity, server(s), platform, etc. Food item service 120 may be associated with an electronic recipe marketplace (e.g., a website, electronic application, widget, etc.) that allows users 104 to search, browse, view and/or acquire (i.e., purchase, rent, lease, borrow, download, etc.) food items 108; may be associated with physical locations where users may purchase food items 108 (e.g., grocery store member service); may be associated with entities that facilitate payment and/or acquisition of food items 108 (e.g., payment services, bank services, shipment services, etc.); or a combination thereof. Food item service 120 may store verification data 116 for one or more users 104 are associated with the food item service 120, such as information corresponding to food items 108 purchased by users (e.g., names of food items 108, brands of food items 108, number of units of food items 108, quantity of food items 108, expiration dates, dates that food items 108 were purchased, nutrition information, etc.). For example, consumption capture application 114 may receive verification data 116 from a grocery store membership service that indicates food items 108 that were purchased by user 104. FIG. 1 illustrates each of the user computing device 102 and food item service 120 as being connected to a network 124, such as the internet.

In some embodiments, food item service 120 may include a pantry service provider. Pantry service provider may be any entity, server(s), platform, etc. Consumption capture application 114 may share consumption profiles 118 with the pantry service provider. Pantry service provider may provide one or more functionalities associated with the consumption capture application 114, such as providing notifications of food item alerts (i.e., expiration, item recalls, price changes, etc.), storage of recipe data corresponding to one or more recipes, storage of user consumption data, etc. In some embodiments, pantry service provider may be associated with an electronic recipe marketplace (e.g., a website, electronic application, widget, etc.) that allows users 104 to search, browse, view and/or acquire (i.e., purchase, rent, lease, borrow, download, etc.) recipes. In some embodiments, the pantry service provider may receive recipe data corresponding to one or more recipes from user computing devices, other user computing devices, or a combination thereof.

Verification data 116 may also be entered directly into and/or detected by the user computing device 102 itself. For example, verification data 116 may comprise information provided by user 104 via a gesture, voice command, a physical interface, a graphical user interface, etc. For example, a user 104 may take a picture of a shopping receipt using a user computing device, and the consumption capture application 114 may identify food items 108 that the shopping receipt indicates the user 104 purchased or otherwise obtained. In another example, the user 104 may use user computing device 102 or another device to take a picture of the bar code or the packaging of a can of creamed corn, and the consumption capture application 114 may generate a consumption profile 118 associated with the can of creamed corn, and which reflects that one can of creamed corn has been added to pantry 106.

The verification data 116 may be acquired by or otherwise input into user computing device 102 via a user interface (e.g., graphical user interface, touchscreen, keyboard, touchpad, etc.), a sensor component of user computing device 102 (e.g., a camera, scanner, microphone, etc.), food item service 120, etc. For example, verification data 116 may correspond to one or more sounds picked up by a microphone element associated with the user computing device 102, appliances 110, or another device. The sounds may be indicative of a recipe action having been performed such as the sound of a blender running; a stand mixer mixing; a food processor chopping; a cabinet, refrigerator, oven, or microwave door being opened/closed; an alarm going off (e.g., microwave notification, timer alarm, oven notification that preheat is finished, etc.); the crack of an eggshell being broken; the hiss of a champagne bottle being opened; or similar.

In some embodiments, generating and updating consumption profiles 118 may include the consumption capture application 114 generating verified Point of Consumption (POC) Data. The consumption capture application 114 may build or otherwise update consumption profiles 118 using point of consumption (POC) data that verifies the consumption of a food item 108 based on recipe data and corroborating verification data 116 received from pantry 106, appliances 110, sensors on the user computing device 102, or a combination thereof. For example, the consumption capture application 114 may generate or modify consumption profiles 118 that correspond to ingredients of a recipe that verification data 116 indicates that user 104 has made.

The POC data may be generated by the consumption capture application 114, or it may be generated by a separate POC application. In some embodiments, the POC applicant and the consumption capture application 114 may be included in a single application. The POC application may be an application for presenting a graphical recipe interface and/or series of visual and/or audio signals that guide user 104 through the process of making a recipe, and generating verified consumption data based on verification data 116 received from appliances 110. For example, for individual steps of a recipe, the POC application may cause user computing device 102 to present an audio instruction to perform the step. In some embodiments, when a recipe step is associated with appliance 110, POC application may also cause appliance 110 to present an audio or visual signal to draw the attention of the user 108 to an aspect of the appliance 110, such as a container on a kitchen scale. For example, a POC application may cause user computing device 102 to transmit a signal to appliance 110 that an audio or video signal is to be provided.

A recipe may include a set of instructional recipe steps for preparing a particular food or drink item. The recipe steps may include one or more actions performed during preparation of the recipe (e.g., adding an ingredient to a container, turning on a blender, preheating an oven, etc.). Appliances 110 may include one or more components that detect evidence of recipe actions, and provide verification data 116 associated with the recipe actions to a user computing device 102. The recipe actions may include one or more actions performed during preparation of the recipe, such as adding an ingredient to a container; turning on a blender; preheating an oven; or inputting commands to a slow cooker, oven, or microwave oven (e.g., setting an oven to broil, setting a burner to medium, programming a microwave to cook for 2 minutes, etc.). Detection of a recipe action may further include a refrigerator or cabinet detecting that an ingredient has been removed and/or replaced with a reduced quantity (e.g., removed a bunch of 7 bananas, returned a bunch of 4 bananas), a thermometer indicating that a goal temperature has been achieved, and similar.

The POC application may receive verification data 116 corresponding to a recipe ingredient. The verification data 116 may be transmitted from pantry 106 and/or appliance 110 to user computing device 102 via a wired or wireless connection. In some embodiments, where the user computing device 102 is integrated into appliance 110, verification data may be passed between one or more sensors of the appliance and a POC application via one or more internal connections. For example, where appliance 110 is a kitchen scale and user 104 adds an ingredient to a container placed upon the kitchen scale, appliance 110 may detect a change in mass of the container and transmit verification data corresponding to the change of mass to a POC application. In another example, for a smoothie recipe the final recipe step may be to cause a kitchen blender appliance to blend the ingredients in a container. When user 104 presses a button to cause the kitchen blender appliance to initiate blending, the kitchen blender appliance may transmit verification data 116 that indicates that the user 104 has initiated blending.

The POC application may then generate consumption data based on verification data 116 received from pantry 106 and/or appliance 110. For example, once a POC application causes a recipe step to be presented to user 104, the POC application may wait for verification data 116 corresponding to the recipe step. The POC application may then verify that the ingredient has been added. Verifying that the ingredient has been added may include comparing the sensor data included in the verification data 116 to expected sensor information for the ingredient. As a further example, a POC application may know that a change in mass that is to be expected when one cup of flour is added to a container, and may compare the verification data 116 to the expected change in mass. If the verification data 116 is within a threshold range of similarity (e.g., plus or minus a threshold percentage, a threshold numerical amount, etc.), then the POC application may verify the ingredient as being added. If the verification data 116 is outside the threshold range, and is indicative of a mistake (i.e., user 104 added too much or too little of an ingredient) the POC application may provide an alert to the user 104 that there has been a mistake, and/or take action to adjust the recipe (e.g., adjust the proportions of other ingredients within the recipe to compensate for the mistake). If the verification data 116 is outside the threshold range the POC application may check to see if the verification data matches an alternative ingredient (i.e., a substitution, a different ingredient in the recipe, etc.), and/or prompt user 104 to add a new ingredient.

The POC application may then generate verified POC data for the verified ingredient. The verified POC data may identify the ingredient, an amount added, one or more times related to the pour event (e.g., time the pour started, time the pour finished, duration of the pour event, etc.), nutritional information for the poured ingredient, a brand or other identifier associated with the ingredient, a user identifier associated with the individual preparing the recipe, an indication that the ingredient was verified by information from the appliance, etc. The verified POC data may correspond to the actual amount indicated in the verification data. For example, if the recipe calls for 33 g of butter to be added, but the verification data indicates that 35.7 g of butter was added to a recipe, the POC application may generate verified POC data that corresponds to 35.7 g of butter being consumed by user 104. In some embodiments, once a recipe application verifies that an ingredient of a recipe has been added, the recipe application may cause another ingredient for the recipe to be presented.

In some embodiments, a POC application may also track ingredients that a user 104 has added without interacting with an appliance 110. For example, the POC application may receive audio input from the user 104 that an ingredient has been added. The recipe application may then verify that the ingredient has been added based on the audio input. The POC application may also receive an input of one or more ingredients that have been added without use of an appliance 110 via graphical interface.

A POC application may also identify that a recipe has been completed without verifying each individual ingredient of the recipe. For example, a POC application may determine that a recipe is complete when a threshold amount of the recipe is completed. In various embodiments, the threshold amount may correspond to a number of verified ingredients added or a percentage of ingredients being verified. A POC application may also determine that a recipe is complete based on input from user 104 (e.g., via a gesture, voice command, a physical interface, a graphical user interface, etc.) or based on other verification data 116. For example, where the final step of a cookie recipe is to bake the cookies, a POC application may determine that all ingredients have been added when an oven appliance sends verification data 116 that the oven has been set to preheat to the correct temperature. The POC application may then verify that all ingredients have been added, and generate consumption data for all of the remaining unverified ingredients in the cookie recipe. Alternatively or in addition, in response to the oven being preheated, the POC application may prompt user 104 to indicate (via a gesture, voice command, a physical interface, a graphical user interface, etc.) what additional unverified ingredients have been added.

A POC application may transmit verified POC data to a consumption capture application 114. The verified POC data may be transmitted from the POC application to the consumption capture application 114 executing on user computing device 102 via a wired or wireless connection. In some embodiments, where a POC application and a consumption capture application 114 are executing on the same user computing device 102, the generated consumption data may be passed to the consumption capture application 114 via one or more internal connections. In some embodiments, a consumption capture application 114 and a POC application may be a single application.

A consumption capture application 114 may generate and/or update one or more consumption profiles 118 based on consumption data to reflect a POC application verifying that user 104 has an ingredient (i.e., food item 108) on hand and/or that user 104 has consumed one or more portions of the ingredient. For example, based on a POC application verifying that a user 104 has added balsamic vinegar to a recipe, a consumption capture application 114 may generate and/or update a consumption profile 118 associated with the balsamic vinegar so that it describes a consumption event corresponding to the addition of balsamic vinegar to the recipe. The description of the consumption event may include an amount of balsamic vinegar used, the purpose of the consumption (e.g., the recipe being made), one or more timestamps associated with the consumption, an amount of balsamic vinegar remaining after the consumption event, etc.

In this way, as a POC application determines that portions of an individual food item 108 are consumed by user 104, a consumption capture application 114 may update a consumption profile 118 to reflect information describing the individual consumption events. In this way, the consumption capture application 114 may use verified POC data to curate consumption profiles 118 for one or more food items 108, where individual consumption profiles 118 describe detailed consumption patterns for a corresponding food item 108 that have been verified as accurate by sensor data.

A consumption capture application 114 may provide recommendations or notifications to user 104 based on consumption profiles 118. For example, a consumption capture application 114 may provide notifications that an individual food item 108 is running low. For example, based on a sensor 112 in pantry 106 detecting that the mass of a food item 108 “brown sugar” is below a threshold amount (e.g., less than 5% of the initial package weight, less than 2 grams, etc.), the consumption capture application 114 may present a message to user 104 that he or she is running low on brown sugar. The consumption capture application 114 may also present the user 104 with functionality to obtain brown sugar, such as an option to add brown sugar to a shopping list, to purchase brown sugar via a food item service 120, etc.

The consumption capture application 114 may also provide notifications that an individual food item 108 is about to expire. For example, when a consumption profile 118 indicates that a food item 108 is about to expire, the consumption capture application 114 may present a user 104 with a visual indication, message, or other indication that the food item 108 is about to expire, and/or may provide a recommendation of one or more recipes that user 104 can make to consume the food item 108 before it expires.

In some embodiments, a consumption capture application 114 may be able to present an interface for user 104 to search for, select, and/or view recipes. The consumption capture application 114 may allow the user 104 to restrict a recipe search so as to only include recipes that can be made with the food items 108 stored in the pantry 106. In some embodiments, consumption capture application 114 may be able to present recommendations of recipes that can be made with food items 108 that the consumption profiles 118 indicate are stored in pantry 106. The consumption capture application 114 may also present indications and/or notifications relating to whether or not the consumption profiles 118 indicate that food items 108 required to make a recipe are stored in the pantry 106. In some embodiments, when one or more consumption profiles 118 indicates that corresponding food items 108 which are required for a recipe are not stored in pantry 106, the consumption capture application 114 may present one or more functionalities for acquiring the required food items 108. For example, the consumption capture application 114 may provide a selectable element for generating a shopping list that includes the required food item 108; adding the required food item 108 to an existing shopping list; purchasing the required item via a food item service 120, etc.

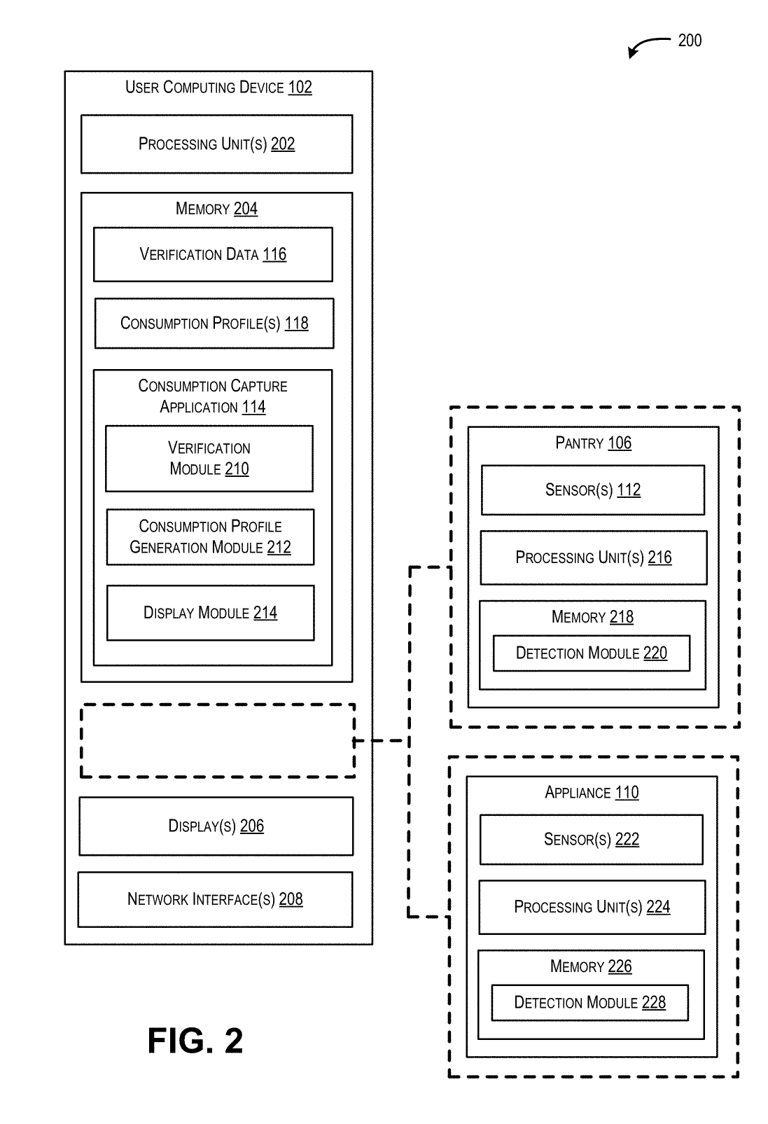

FIG. 2 is an illustrative computing architecture 200 of a computing device configured to generate and manage consumption profiles 118 for food items 108 consumed by a user 104. The computing architecture 200 may be used to implement the various systems, devices, and techniques discussed herein. In various embodiments, user computing device 102 may be implemented on any type of device, such as a laptop computer, personal computer, voice controlled computing device, a tablet device, a mobile telephone, etc.

In the illustrated implementation, the computing architecture 200 includes one or more processing units 202 coupled to a memory 204. The computing architecture may also include a display 206 and/or network interface 208. FIG. 2 further illustrates pantry 106 and appliance 110 as being separate from user computing device 102. However in some embodiments, one or more of pantry 106 and appliance 110 may be incorporated as a component of the user computing device 102, or vice versa.

The user computing device 102 can include verification data 116 and one or more consumption profiles 118 stored on the memory 204. Verification data 116 may be information that evidences one or more of an acquisition of a food item 108 and/or a consumption event where one or more food items 108 are being consumed. Verification data 116 may be provided to the user computing device 102 by a pantry 106, appliances 110, a food item service 120, or a combination thereof. In some embodiments, verification data 116 may correspond to sensor data from one or more sensors 112 located within pantry 106 and/or appliance 110. In some embodiments, verification data 116 may be transmitted to user computing device 102 from one or more of pantry 106 and appliance 110 via a wired or wireless communications means. Verification data 116 may also be entered directly into and/or detected by the user computing device 102 itself. For example, verification data 116 may comprise information provided by user 104 via a gesture, voice command, a physical interface, a graphical user interface, etc.

The consumption profiles 118 may be a collection of data associated with one or more food items 108. In some embodiments, consumption profiles 118 may include information such as the name of a food item 108, size of the food item 108, statistics describing individual consumption events associated with the food item 108 (i.e., instances of usage of the food item 108 captured by the consumption capture system), times of consumption events, timetable of consumption of the food item 108, amount of the food item 108 consumed before expiration, etc.

The user computing device 102 can also include a consumption capture application 114 stored on the memory 204. The consumption capture application 114 may be configured to receive and/or otherwise determine verification data 116. Alternatively or in addition the consumption capture application 114 may be configured to generate and maintain consumption profiles 118 for food items 108 stored in pantry 106.

The consumption capture application 114 may include verification module 210, consumption profile generation module 212, and display module 214. As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of the modules can be implemented in whole or in part by hardware (e.g., a specialized processing unit, etc.) to execute the described functions. In various implementations, the modules described herein in association with user computing device 102 can be executed across multiple devices.

The verification module 210 can be executable by the one or more processing units 202 to receive user input, sensor data, account information, etc., and verify the occurrence of a consumption event associated with a food item 108. In some embodiments, the verification module 210 can be executable to verify the occurrence of a consumption event by generating verification data 116 associated with a food item 108. In some embodiments, the verification data 116 may be manually entered by a user 104 via one or more interfaces associated with the user computing device 102, pantry 106, and/or appliance 110. For example, verification module 210 may present on display 206 a graphical user interface that presents functionality that allows a user 104 to selectively input the food items 108 that the user 104 is consuming and/or storing in the pantry 106.

Alternatively or in addition, the verification module 210 may generate the verification data 116 based on sensor data received via sensors associated with the user computing device 102, pantry 106, and/or appliance 110. For example, a user 104 may scan food items 108 with a sensor (e.g., bar code scan, QR code scan, RFID tag scan, photograph of food item packaging, etc.) independent from, or incorporated into user computing device 102, pantry 106, and/or appliance 110, which may be used by the verification module 210 to generate verification data 116 associated with the food item 108. In another example, a user 104 may photograph or otherwise scan receipts of food items 108 purchased from a vendor. The verification module 210 may then identify a set of food items 108 that the shopping receipt indicates the user 104 purchased, and generate verification data 116 for the set of food items 108.

Alternatively or in addition, the verification module 210 may generate the verification data 116 based on sensor data received via one or more sensors 112 in pantry 106 and/or appliance 110. For example, sensor(s) 112 may detect images of food items 108 stored in pantry 106, detect RFID signal from food items 108 stored in pantry 106, etc. Sensor(s) 112 may also detect changes in mass, size, and/or volume of food items 108 stored in the pantry 106 over a period of time. The verification module 210 may then generate verification data 116 based on the sensor data.

The verification module 210 may also generate verification data 116 based on account information associated with one or more user accounts, such as grocery store membership accounts, an account with a shopping list application, accounts associated with electronic shopping services, credit card accounts, or other user accounts that may provide information relating to food items 108 purchased or otherwise acquired by an individual. The verification module 210 may receive the account information from a food item service 120, such as an electronic recipe marketplace (e.g., a website, electronic application, widget, etc.) that allows users 104 to search, browse, view and/or acquire (i.e., purchase, rent, lease, borrow, download, etc.) food items 108; a store having physical locations where users 104 may purchase food items 108 (e.g., grocery store member service); entities that facilitate payment and/or acquisition of food items 108 (e.g., payment services, bank services, shipment services, etc.); or a combination thereof. For example, verification module 210 may receive account information from a payment service that indicates a set of food items 108 that were purchased by user 104, and then generate verification data 116 that corresponds to the set of food items 108 having been acquired. The verification module 210 may receive the account information from a server associated with the food item service 120, a computing device associated with the food item service 120, an application executing on user computing device 102, or a combination thereof.

Alternatively or in addition, the verification module 210 can be executable by the one or more processing units 202 to receive verification data 116 associated with a food item 108 from one or more of user computing device 102, pantry 106, appliance 110, and food item service 120; verify the occurrence of a consumption event; and then generate POC data based on the verification data 116.

In some embodiments, the verification module 210 may generate POC data that verifies the consumption of a food item 108 based on recipe data and corroborating verification data 116 received from one or more of user computing device 102, pantry 106, appliance 110, and food item service 120. In some embodiments, the verification module 210 may cause user computing device 102 to present a graphical recipe interface and/or series of visual and/or audio signals that guide user 104 through the process of making a recipe. In some embodiments, for individual steps of a recipe, the user computing device 102 may present a visual or audio instruction to perform the step. A recipe may include a set of instructional recipe steps for preparing a particular food or drink item. The recipe steps may include one or more actions performed during preparation of a recipe (e.g., adding an ingredient to a container, turning on a blender, preheating an oven, etc.). In some embodiments, when a recipe step is associated with appliance 110, appliance 110 may present an audio or visual signal to draw the attention of the individual to an aspect of the appliance 110, such as a container on a kitchen scale. For example, POC application 114 may cause user computing device 102 to transmit a signal to appliance 110 that an audio or video signal is to be provided.

Appliance 110 may include one or more components that detect evidence of recipe actions, and provide verification data associated with the recipe actions to the user computing device 102. The recipe actions may include one or more actions performed during preparation of a recipe, such as adding an ingredient to a container; turning on a blender; preheating an oven; inputting commands to a slow cooker, oven, or microwave oven (e.g., setting an oven to broil, setting a burner to medium, programming a microwave to cook for 2 minutes, etc.). Evidence of recipe actions may include a refrigerator or cabinet detecting that an ingredient has been removed and/or replaced with a reduced quantity (e.g., removed a bunch of 7 bananas, returned a bunch of 4 bananas), a thermometer indicating that a goal temperature has been achieved, or similar. In response to detecting a recipe action, appliance 110 may then transmit verification data 116 associated with the detected recipe action.

The verification module 210 may then generate POC data for the recipe ingredient based on the user computing device 102 receiving verification data 116 associated with the detected recipe action. In some embodiments, generating the POC data may include confirming that verification data 116 corresponds to sensor information that is expected for a recipe ingredient. Confirming that the ingredient has been added may include comparing the sensor data included in the verification data 116 to expected sensor information for the expected recipe ingredient. For example, when a recipe step corresponds to adding two tablespoons of baking soda to a container, the verification module 210 may compare the verification data to a known mass of two tablespoons of baking soda. If the verification data is within a threshold range of similarity (e.g., plus or minus a threshold percentage, a threshold numerical amount, etc.), then the verification module 210 may verify that the ingredient has been added, and generate POC data for the ingredient.

If the verification data is outside the threshold range, and is indicative of a mistake (i.e., user 104 added too much or too little of an ingredient) the verification module 210 may provide an alert to the user 104 that there has been a mistake, and/or take action to adjust the recipe (e.g., adjust the proportions of other ingredients within the recipe to compensate for the mistake). Alternatively or in addition, if the verification data is outside the threshold range verification module 210 may check to see if the verification data matches an alternative ingredient (i.e., a substitution, a different ingredient in the recipe, etc.), and/or prompt user 104 to identify the ingredient that was added. The verification module 210 may then generate POC data for the alternative ingredient or the ingredient identified by the user 104.

In some embodiments, the sensor data, verification data, or user input may include an identifier associated with a food item 108, and generating POC data may include the verification module 210 using the identifier to access item information associated with the food item 108. For example, where the verification module 210 receives data associated with an item barcode information, the verification module 210 may use the barcode information to obtain information corresponding to the food item 108 from a food item resource, such as a locally stored database, a network resource, or similar. In another example, where the verification module 210 receives an image of the packaging of a food item 108, the verification module 210 may identify a name, brand, or other identifier of the food item 108 within the image, which the verification module 210 may use to request food item information from a locally stored database, a network resource, or similar.

In some embodiments, generating POC data may correspond to the verification module 210 converting sensor data into food item information. For example, when generating POC data, verification module 210 may receive sensor data from a sensor incorporated into a scale that corresponds to an item having a mass of 259 grams being placed on the scale. The verification module 210 may then generate POC data that corresponds to the item having a mass of 259 g. Furthermore, if the verification module 210 determines that the item corresponds to the food item 108 “flour,” the corresponding POC data may also identify the food item 108 as “flour,” and calculate that 259 g of flour corresponds to approximately 2.16 cups of flour.

The consumption profile generation module 212 can be executable by the one or more processing units 202 to generate and/or update consumption profiles 118 associated with food items 108. The consumption profile generation module 212 may generate the consumption profiles 118 based on verification data 116, POC data, or a combination thereof. An individual consumption profile 118 may include a data log of consumption events associated with the food item 108. For example, a consumption profile 118 for a 12 oz. container of olive oil may identify one or more consumption events in which verification data 116 and/or POC data confirmed that a portion of the olive oil was consumed, as well as information associated with individual consumption events, such as the amount of olive oil used, the date of the event, the purpose for the use (e.g., sautéing vegetables, homemade salad dressing, etc.), the amount of olive oil remaining after the consumption event, etc. Additionally, individual consumption profiles 118 may store information associated with the corresponding food item 108, such as nutritional information; brand information; food types; flavors; state information of the food item 108 (e.g., quantities/amounts stored in pantry 106, dates the food item 108 was purchased, expiration data associated with the food item 108, etc.); and/or other information.

The consumption profile generation module 212 may also update an existing consumption profile 118 based on verification data 116, POC data, or a combination thereof generated or otherwise received by verification module 210. For example, based on the verification module 210 verifying that a user 104 has added one cup of flour to a blueberry muffin recipe, the consumption profile generation module 212 may update the consumption profile 118 associated with flour so that it includes information associated with this consumption event, such as the time that the consumption event occurred, that one cup of flour was used, that it was used to make blueberry muffins, and that the quantity of the flour stored in pantry 106 has been reduced by 1 cup.

Where the verification module 210 verifies a consumption event associated with a food item 108 for which there is not a corresponding consumption profile 118, the consumption profile generation module 212 may generate a new consumption profile 118 for the food item 108. For example, in response to a user 104 scanning a shopping receipt, verification module 210 may verify that the user 104 has obtained a one gallon container of the food item 108 “vanilla ice cream,” and the consumption profile generation module 212 may generate a new consumption profile 118 associated with the one gallon container of vanilla ice cream. Then, as the verification module 210 verifies the occurrence of consumption events associated with the one gallon container of vanilla ice cream, the consumption profile generation module 212 updates the corresponding consumption profile 118 so that it reflects the current state of the food item 108, as well as information associated with each individual verified consumption event.

The display module 214 can be executable by the one or more processing units 202 to provide a graphical user interface (GUI) that presents visual representations of consumption profiles 118. For example, the display module 214 may generate a GUI that displays both typographical information and visual information associated with the consumption of a corresponding food item 108. Typographical information may include a name of the good, a size of the good, acquisition date, expiration date, frequency of consumption vents, frequent usages of the good, etc. Visual information may display consumption events of the item using one or more of a graph, pictogram, histogram, or other visual representation that conveys the history of consumption of the food item 108 corresponding to the consumption profile 118. The visual information may include one or more visual representations of individual consumption events, which may depict information such as date of the consumption event, purpose of the consumption event, amount consumed during the consumption event, etc.

In some embodiments, the display module 214 may also present one or more recommendations or notifications based on the consumption profiles. For example, the display module 214 may provide notifications that an amount/quantity of an individual food item 108 stored in pantry 106 has dropped below a threshold value. For example, based on a sensor in pantry 106 detecting that the mass of a food item 108 “coconut milk” is below a threshold amount (e.g., less than 5% of the original package weight, less than 2 grams, etc.), the display module 214 may present a message that the user 104 is running low on coconut milk. The display module 214 may also present the user 104 with functionality to acquire coconut milk, such as an option to add coconut milk to a shopping list, to purchase brown sugar via a food item service 120, etc.

In some embodiments, the display module 214 may provide notifications that an individual food item 108 is about to expire. For example, a consumption profile 118 may include an expiration date associated with the food item 108 and an estimated time at which the food item 108 will be fully consumed. When a consumption profile 118 indicates that a food item 108 is likely to expire before it is fully consumed (i.e., the estimated time that consumption of the food item 108 will be completed is later than the expiration date), the display module 214 may present the user 104 with a visual indication, message, or other indication that the food item 108 is about to expire, and/or provide a recommendation of one or more recipes that user 104 can make to consume the food item 108 before it expires.

FIG. 2 further depicts pantry 106 and appliance 110. Pantry 106 may include one or more storage spaces for storing food items 108 (e.g., cabinets, shelving, refrigerators, freezers, or other storage resources). In some embodiments, one or more of the storage spaces of pantry 106 may include one or more sensors 112 for monitoring food items 108 contained therein.

Sensors 112 may include any combination of one or more optical sensors (e.g., camera, barcode scanner, etc.), pressure sensors (e.g., capacitance sensors, piezoelectric sensors, etc.), acoustic sensors (e.g., microphones, etc.), or other sensors capable of receiving input or other otherwise detecting characteristics of food items 108 in pantry 106 and/or the environment of pantry 106. For example, pantry 106 may include one or more sensors that can capture photographs of the labels and/or packaging of food items 108 stored within the pantry 106. In some embodiments, pantry 106 may further include processing unit(s) 216, and memory 218. The pantry 106 can include a detection module 220 stored on the memory 218. The detection module 220 can be executable by the one or more processing units 216 to monitor sensor data from sensors 112 and transmit the sensor data to the user computing device 102. In some embodiments, the detection module 220 may also be configured to generate verification data 116 based on the sensor data, and transmit the verification data 116 to the user computing device 102.

Appliance 110 may be a scale, oven, blender, mixer, refrigerator, food thermometer, or other type of tool used to store and/or prepare food. Appliance 110 may include one or more sensors 222 that detect evidence of ingredients being added and/or recipe steps being executed. Sensors 222 may include any combination of one or more optical sensors (e.g., camera, barcode scanner, etc.), pressure sensors (e.g., capacitance sensors, piezoelectric sensors, etc.), acoustic sensors (e.g., microphones, etc.), or other sensors capable of receiving input or other otherwise detecting characteristics of appliance 110 and/or the environment of appliance 110.

In some embodiments, appliance 110 may further include processing unit(s) 224 and memory 226. Appliance 110 can include a detection module 228 stored on the memory 226. The detection module 228 can be executable by the one or more processing units 224 to monitor sensor data from sensors 222 and transmit the sensor data to the user computing device 102. In some embodiments, the detection module 228 may also be configured to generate verification data 116 based on the sensor data, and transmit the verification data 116 to the user computing device 102.

Those skilled in the art will appreciate that the architecture described in association with user computing device 102, pantry 106, and appliance 110 are merely illustrative and is not intended to limit the scope of the present disclosure. In particular, the computing system and devices may include any combination of hardware or software that can perform the indicated functions, including computers, network devices, internet appliances, and/or other computing devices. The user computing device 102, pantry 106, and appliance 110 may also be connected to other devices that are not illustrated, or instead may operate as a stand-alone system. In addition, the functionality provided by the illustrated components may in some implementations be combined in fewer components or distributed in additional components. For example, in some embodiments user computing device 102 may be incorporated into pantry 106, appliance 110, or both. Similarly, in some implementations, the functionality of some of the illustrated components may not be provided and/or other additional functionality may be available.

The one or more processing unit(s) 202, 216, and 224 may be configured to execute instructions, applications, or programs stored in the memory(s) 204, 218, and/or 226. In some examples, the one or more processing unit(s) 202, 216, and 224 may include hardware processors that include, without limitation, a hardware central processing unit (CPU), a graphics processing unit (GPU), and so on. While in many instances the techniques are described herein as being performed by the one or more processing units unit(s) 202, 216, and 224, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memory 204, 218, and 226 is an example of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer-executable instructions that, when executed by one or more processing units, cause various functions and/or operations described herein to be performed.

Additionally, a computer media includes data stored within a modulated data signal. For example, a computer media may include computer readable instructions, data structures, program modules, modulated carrier waves, other modulated transmission mechanisms, etc. However, as defined herein, computer storage media does not include communication media.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated computing architecture 200. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from user computing device 102, pantry 106, and/or appliance 110 may be transmitted to user computing device 102, pantry 106, and/or appliance 110 via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible medium.

Additionally, the network interface 208 includes physical and/or logical interfaces for connecting the respective computing device(s) to another computing device or network. For example, the network interface 208 may enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein may include many other logical, programmatic, and physical components, of which those shown in the accompanying figures are merely examples that are related to the discussion herein.

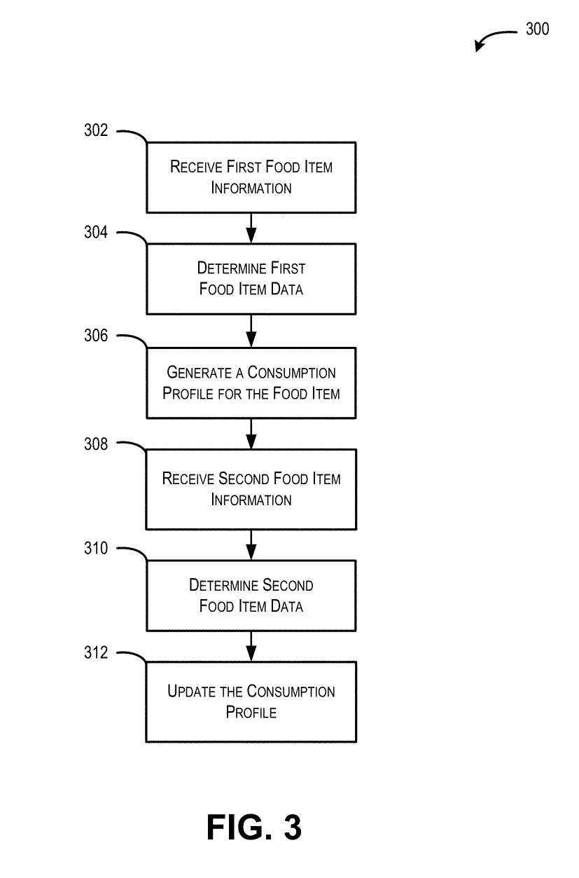

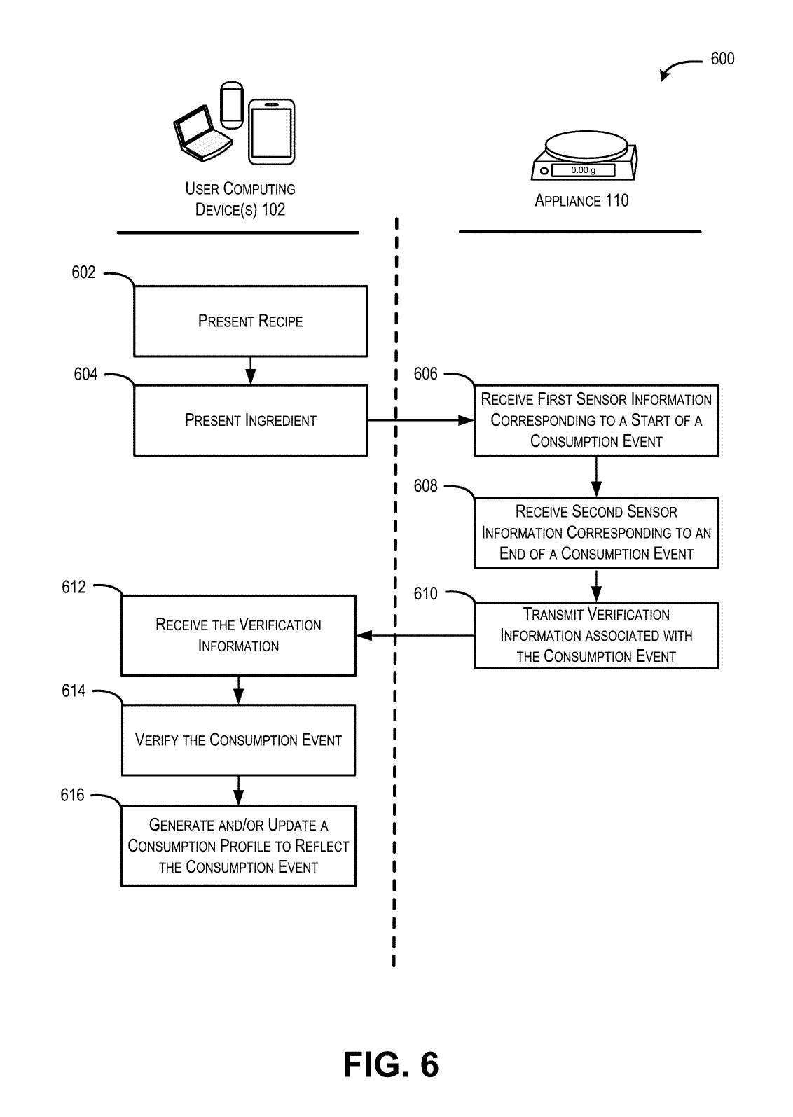

FIGS. 3 and 6 are flow diagrams of illustrative processes illustrated as a collection of blocks in a logical flow graph, which represent a sequence of operations that can be implemented in hardware, software, or a combination thereof. The blocks are organized under entities and/or devices that may implement operations described in the blocks. However, other entities/devices may implement some blocks. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram of an illustrative process 300 for generating and managing a consumption profile for a food item 108. The process 300 may be implemented by the computing architecture 200 and in the environment 100 described above, or in other environments and architectures.

At 302, user computing device 102 receives first food item information. The first food information may correspond to user input, sensor information, user account information, user point of consumption (POC) data, or other data that indicates that one or more first food items 108 have been purchased and/or used in association with a user 104. In some embodiments, the first food item information may be manually entered into a user computing device 102, or may be acquired by scanning the one or more first food items 108 (e.g., bar code scan, QR code scan, RFID tag scan, photograph of food item packaging, etc.), photographing or scanning receipts of the one or more first food items 108 purchased from a vendor, reading sensor data from one or more sensors in a smart storage space, or by similar means.

Alternatively or in addition, the first food item information may be received by the user computing device 102 via account information 122 associated with one or more user accounts, such as grocery store membership accounts, an account with a shopping list application, accounts associated with electronic shopping services, credit card accounts, or other user accounts that may provide information relating to food items 108 purchased or otherwise acquired by an user 104. In some embodiments, the first food information may be received from one or more applications and or/programs executing on the user computing device 102 or another computing device.

At 304, the user computing device 102 determines first food item data. The first food item data may be information relating to the first one or more food items 108, such as types of food items 108; names of food items 108; brands of food items 108; number of units of food items 108; quantity of food items 108 remaining in a unit; expiration dates for food items 108; dates that food items 108 were purchased; nutrition information; etc. In some embodiments, the user computing device 102 determines the first food item data based on the first food item information. In some embodiments, the user computing device 102 may determine one or more portions of the first food data directly from the food item information. For example, the user computing device 102 may identify within a scanned image of a receipt quantities of food items 108 listed on the receipt. In another example, the user computing device 102 may identify names of food items 108 within a description of the food items 108 that was input by a user 104.

Alternatively, or in addition the user computing device 102 may indirectly use information from the food item information to determine one or more portions of the first food data. For example, the user computing device 102 may utilize an identifier associated with a food item 108 (e.g., name, UPC code, etc.) to access food data for the food item 108. In some embodiments, the user computing device 102 may use the identifier to request food item information from a locally stored database. Alternatively or in addition, the user computing device 102 may use the identifier to request food item information from a network resource, such as food item service 120 or a pantry service provider.

In some embodiments, determining first food item data may include verifying a consumption event associated with the food item 108, and then determining food data associated with the consumption event. For example, the user computing device 102 may determine that the first food item information verifies an instance where the food item 108 was consumed, and may then generate food data that includes information about the consumption event, such as the name of the food item 108, size of the food item 108, statistics describing the verified consumption event associated with the food item 108, times associated with the verified consumption event, amount of the food item 108 consumed, etc.

At 306, user computing device 102 generates a consumption profile 118 for the food item 108. The consumption profile 118 may be a collection of data associated with the corresponding food item 108. In some embodiments, the consumption profiles 118 may include information such as the name of the food item 108, size of the food item 108, statistics describing individual consumption events associated with the food item 108 (i.e., instances of usage of the food item 108 captured by the consumption capture system), times of consumption events, timetable of consumption of a food item 108, amount of the food item 108 consumed before expiration, etc. For example, a consumption profile 118 for a 16 oz. container of marinara sauce may identify one or more consumption events in which the user computing device 102 verified that a portion of the marinara sauce was consumed, as well as information associated with individual consumption events, such as the amount of marinara sauce used, the date of the consumption event, the purpose for the use (e.g., meatball sandwich, baked ziti, etc.), the amount of marinara sauce remaining after the consumption event, etc. Additionally, the consumption profile may store information associated with the marinara sauce, such as nutritional information; brand information; food types; flavors; state information of the marinara sauce (e.g., quantities/amounts stored in pantry 106, date the marinara sauce was purchased, expiration data associated with the marinara sauce, etc.); and/or other information.

At 308, user computing device 102 receives second food item information. The second food information may correspond to user input, sensor information, user account information, user point of consumption (POC) data, or other data that indicates one or more second food items 108 purchased and/or used in association with a user 104. The second food information may be received via a combination of one or more sources by which the first food item information, via a combination of one or more different sources, or a combination thereof. For example, the second food item information may correspond to a scan of a shopping receipt that identifies the one or more second food items 108 as having been purchased.

At 310, user computing device 102 determines second food item data. The second food item data may be information relating to the second one or more food items 108, such as types of food items 108; names of food items 108; brands of food items 108; number of units of food items 108; quantity of food items 108 remaining in a unit; expiration dates; dates that food items 108 were purchased; nutrition information; etc. In some embodiments, the user computing device 102 determines the second food item data based on the second food item information.

Determining the second food item data may include verifying a second consumption event associated with the food item 108, and then determining food data associated with the second consumption event. For example, the user computing device 102 may determine that the second food item information verifies a second instance where the food item 108 was consumed, and may then generate food data that includes information about this second consumption event such as the name of the food item 108, size of the food item 108, statistics describing the verified consumption event associated with the food item 108, times associated with the verified consumption event, amount of the food item 108 consumed, etc.

At 312, user computing device 102 updates the consumption profile. In some embodiments, user computing device 102 may update the consumption profile using the second food item data, such that the consumption profile reflects the second food item data. For example, where the second food item data includes information associated with a verified second consumption event where one half cup of the marinara sauce is used to make a meatball sandwich, the user computing device 102 may update the consumption profile associated with the marinara sauce so that it indicates information associated with the second consumption event, such as the amount of marinara sauce used, the date of the consumption event, the purpose for the use, the amount of marinara sauce remaining after the consumption event, etc.

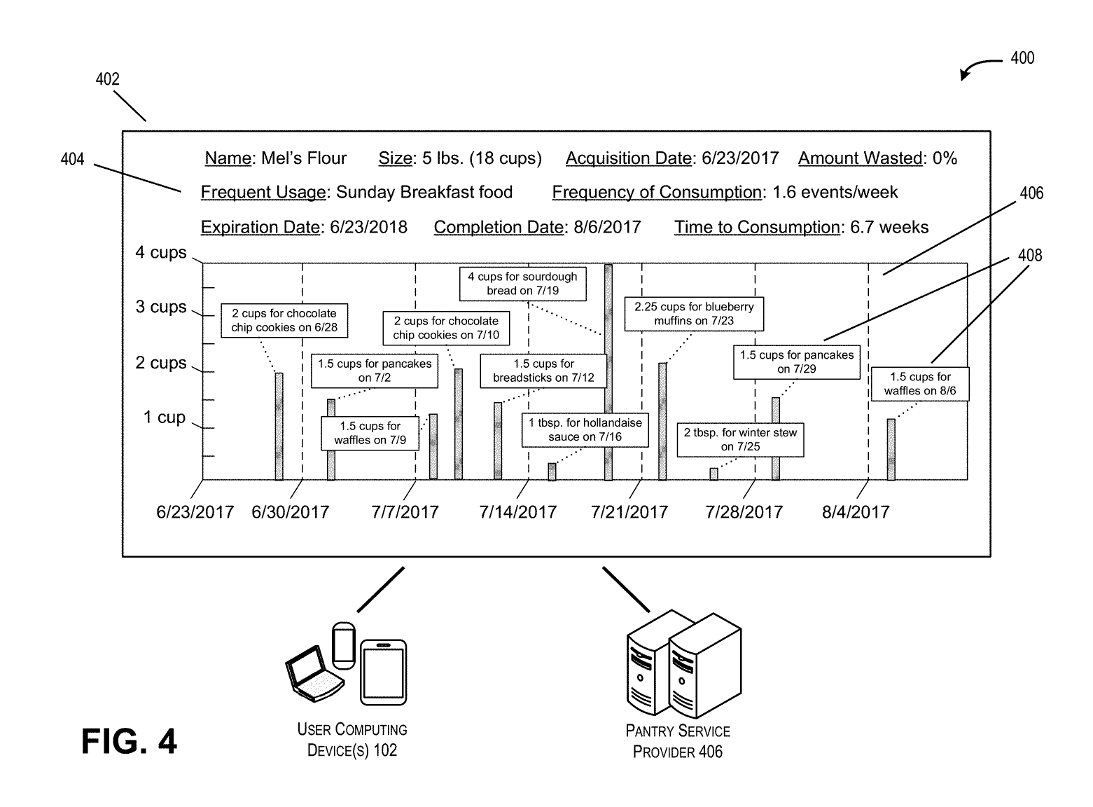

FIG. 4 is an illustration 400 of a graphical user interface that visually presents a consumption profile for a fully consumed food item 108. FIG. 4 depicts an example graphical user interface (GUI) 402 that visually presents information included within a consumption profile 118 associated with the food item 108 “flour.” In some embodiments, GUI 402 may be presented on one or more displays associated with user computing device 102, pantry service provider 406, or both. Alternatively or in addition, GUI 402 may be presented on one or more displays associated with pantry 106 and/or appliances 110.

FIG. 4 depicts GUI 402 as displaying both typographical information 404 and visual information 406 associated with the food item 108 “flour.” Typographical information 404 may include a name of the good, a size of the good, acquisition date, expiration date, frequency of consumption vents, frequent usages of the good, etc. The consumption profile 118 depicted in GUI 402 is a completed consumption profile (i.e., the good has been verified as having been completely consumed). Where the consumption profile is complete for the good, the typographical information 404 may include additional information such as a completion date, a time to consumption, an amount wasted, etc. Visual information 406 may graphically consumption events of the item using one or more of a graph, pictogram, histogram, or other visual representation that conveys the history of consumption of the food item 108 corresponding to the consumption profile. The visual information 406 may include one or more visual representations of individual consumption events 408, which may depict information such as date of the consumption event, purpose of the consumption event, amount consumed during the consumption event, etc.

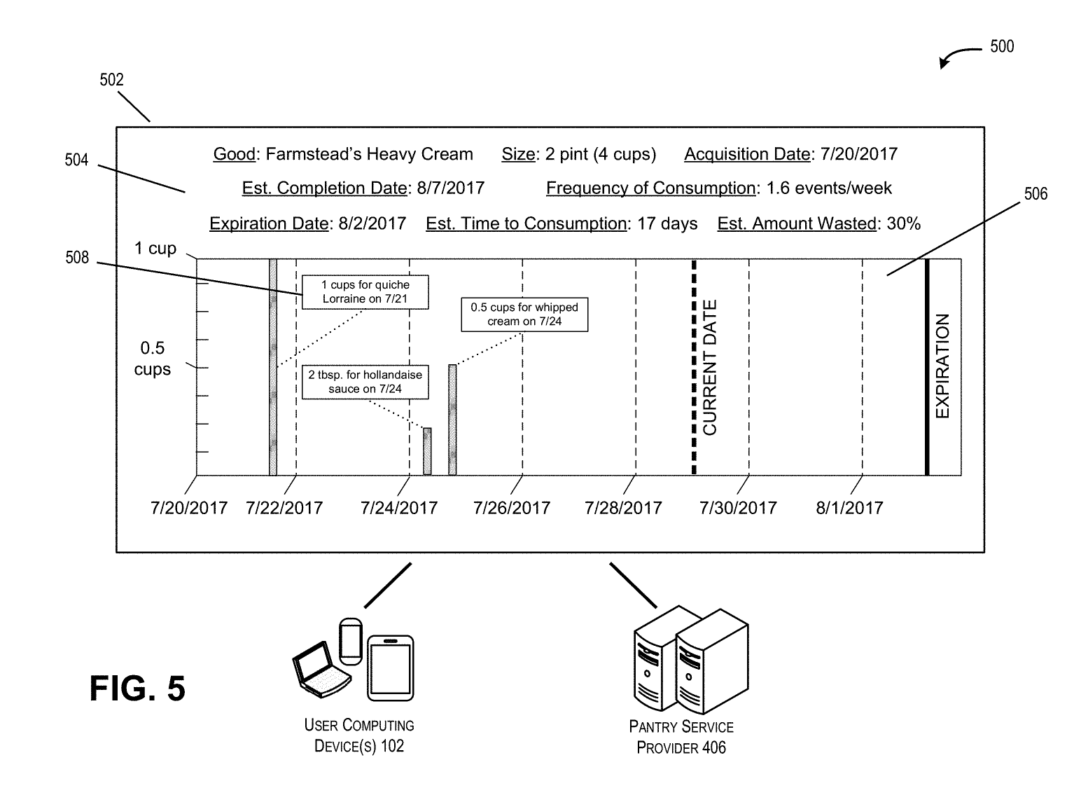

FIG. 5 is an illustration 500 of a graphical user interface that visually presents a consumption profile for a partially consumed food item 108. FIG. 5 depicts an example graphical user interface (GUI) 502 that visually presents information included within a consumption profile 118 associated with the food item 108 “heavy cream.” In some embodiments, GUI 502 may be presented on one or more displays associated with user computing device 102, pantry service provider 406, or both. Alternatively or in addition, GUI 502 may be presented on one or more displays associated with pantry 106 and/or appliances 110.

FIG. 5 depicts GUI 502 as displaying both typographical information 504 and visual information 506 associated with the food item 108 “heavy whipping cream.” Typographical information 504 may include a name of the good, a size of the good, acquisition date, expiration date, frequency of consumption vents, etc. The consumption profile 118 depicted in GUI 502 is a partially consumption profile (i.e., the good has not been verified as having been completely consumed). Where the consumption profile is incomplete for the good, the typographical information 504 may include estimations for consumption of the good such as an estimated completion date, an estimated time to consumption, and an estimated amount wasted, etc. The estimations may be computed by one or more of the user computing device 102 and pantry service 122, and may be based upon verified consumption data associated with the food item 108, usage patterns of an associated user 104, usage patterns of other users 104, geographic or temporal usage trends, etc.

Visual information 506 may graphically depict consumption events of the item using one or more of a graph, pictogram, histogram, or other visual representation that conveys the history of consumption of the food item 108 corresponding to the consumption profile. The visual information 506 may include one or more visual representations of individual consumption events 508, which may depict information such as date of the consumption event, purpose of the consumption event, amount consumed during the consumption event, etc. Where the GUI 502 depicts a partially completed consumption profile, the visual information 506 may include visual representations of an expiration date, a current date, an estimated completion date, anticipated and/or planned future consumption events, etc.

FIG. 6 is a flow diagram of an illustrative process 600 for using verification data 116 from an appliance 110 to verify consumption events, and generating and managing consumption profiles 116 to reflect the verified consumption events. The process 600 may be implemented by the computing architecture 200 and in the environment 100 described above, or in other environments and architectures.

At 602, user computing device 102 presents a recipe. A recipe may include a set of instructions for preparing a particular food or drink item. In some embodiments, presenting the recipe may include causing a graphical recipe interface to be presented on a display. In some embodiments, the graphical recipe interface presents one or more recipe steps/ingredients that are to be performed. The display may be part of the user computing device 102, or may be a component of another computing device. In embodiments where the user computing device 102 is incorporated as part of an appliance 110, the graphical recipe interface may be presented on a display incorporated into the appliance 110.

At 604, user computing device 102 identifies an expected ingredient. For example, the user computing device 102 may determine an ingredient that is to be next added during completion of the recipe. An ingredient may include any component of a recipe, including raw food items 108 (e.g., eggs, butter, oats, carrots, chicken breast, etc.), and prepared food items 108 (e.g., ice cream, butter, pasta sauce, etc.). The expected ingredient may be selected based on a predetermined order associated with the recipe (e.g., always start recipe by adding flour), a suggested ingredient order (e.g., dry ingredients must be added before wet ingredients), past user behavior, contextual data, or other factors. In some embodiments, once the expected ingredient has been selected, the user computing device 102 may cause the graphical recipe interface to include an ingredient block corresponding to the expected ingredient. Alternatively or in addition, the user computing device 102 may cause an audio instruction to add the ingredient to be presented.

At 606, an appliance 110 receives first sensor information corresponding to a start of a consumption event. In some embodiments, the appliance 110 may be a kitchen scale configured to detect a change in mass that corresponds to an ingredient beginning to be added to a container. For example, where the user computing device 102 has directed an individual to add an ingredient to a container, the kitchen scale may detect that the container has been placed onto the scale, and then detect a change in the mass of the container indicative of the ingredient being added.

At 608, appliance 110 receives second sensor information corresponding to an end of the consumption event. In some embodiments, the second sensor information may correspond to the mass of the container becoming stable (i.e., the appliance detecting that the changing mass indicative of an ingredient being added to the container has stabilized). For example, where the appliance 110 is a kitchen scale, and here the kitchen scale has detected a change in mass of the container indicative of an ingredient being added, the kitchen scale may detect that the mass of the container has remained stable for a set period of time. In some embodiments, the kitchen scale may determine that the mass has remained stable based on the mass remaining within a threshold range for a preset period of time.

At 610, appliance 110 transmits verification information associated with the pour event to the user computing device 102. For example, appliance 110 may determine a portion of sensor data that is indicative of a consumption event, and transmit the portion of data to the user computing device 102. Alternatively, transmitting the verification information may include the appliance 110 transmitting all sensor data to the user computing device 102. The verification information may be transmitted from appliance 110 to user computing device 102 via a wired or wireless connection. In some embodiments, where the user computing device 102 is integrated into appliance 110, the verification data may be passed between one or more sensors of the appliance and a point of consumption application executing on the user computing device 102 via one or more internal connections.

At 612, user computing device 102 receives the pour event information from the appliance 110. For example, where appliance 110 is a kitchen scale and an ingredient is added to a container placed upon the kitchen scale, appliance 110 may transmit verification data 116 corresponding to one or more of the change of mass, an initial mass, a final mass, timing information for the pour event, etc.

At 614, user computing device 102 verifies the consumption event. For example, the user computing device 102 may compare the sensor data included in the verification information to expected sensor information for the expected ingredient to verify that the ingredient was actually consumed. In some embodiments, the user computing device 102 may know a change in mass that is to be expected when an ingredient is added, and may compare the verification data to the expected mass. The expected sensor information may be included within the recipe data for the recipe, or may be computed by the user computing device 102 using characteristics of the ingredient. For example, recipe data for the recipe may indicate that one teaspoon of baking soda has a mass of 11 grams. The user computing device 102 can then compute the expected sensor information for 2 tablespoons of baking soda using the ratio of 1 tsp.=11 g.

If the verification information indicates that the sensor data is within a threshold range of similarity (e.g., plus or minus a threshold percentage, a threshold numerical amount, etc.), then the user computing device 102 may verify the ingredient as having been added and/or that a consumption event occurred in which a verified amount of the ingredient was consumed. If the verification information is outside the threshold range, the user computing device 102 may determine that the sensor data is indicative of a mistake by the user 104 (i.e., the user 104 added too much or too little of an ingredient), and the user computing device 102 may cause an alert to be provided to the user 104. Alternatively or in addition, the user computing device 102 may present a notification to the user 104 that there has been a mistake, and/or present a suggested action for the user 104 to take fix the mistake (e.g., adjust the proportions of other ingredients within the recipe to compensate for the mistake).

At 616, user computing device 102 generates and/or updates a consumption profile 118 associated with the ingredient to reflect the consumption event. Where the user computing device 102 determines that a consumption profile 118 does not exist for the ingredient, the user computing device 102 may generate a new consumption profile 118 for the ingredient and update it to include data for the verified consumption event, such as an actual amount that the verification information indicated was consumed in the consumption event. The consumption profile 118 may be a collection of data associated with the corresponding food item 108. In some embodiments, the consumption profiles 118 may include information such as the name of the food item 108, size of the food item 108, statistics describing individual consumption events associated with the food item 108 (i.e., instances of usage of the food item 108 captured by the consumption capture system), times of consumption events, timetable of consumption of a food item 108, amount of the food item 108 consumed before expiration, etc.

Where the user computing device 102 determines that a consumption profile 118 already exists for the food item 108, the user computing device 102 may update the consumption profile 118 to reflect the consumption event. For example, the user computing device 102 may update the consumption profile 118 to include information about the verified consumption event, such as an amount of the food item 108 that is consumed during the consumption event, a purpose associated with the consumption event, one or more times associated with the consumption event, etc.

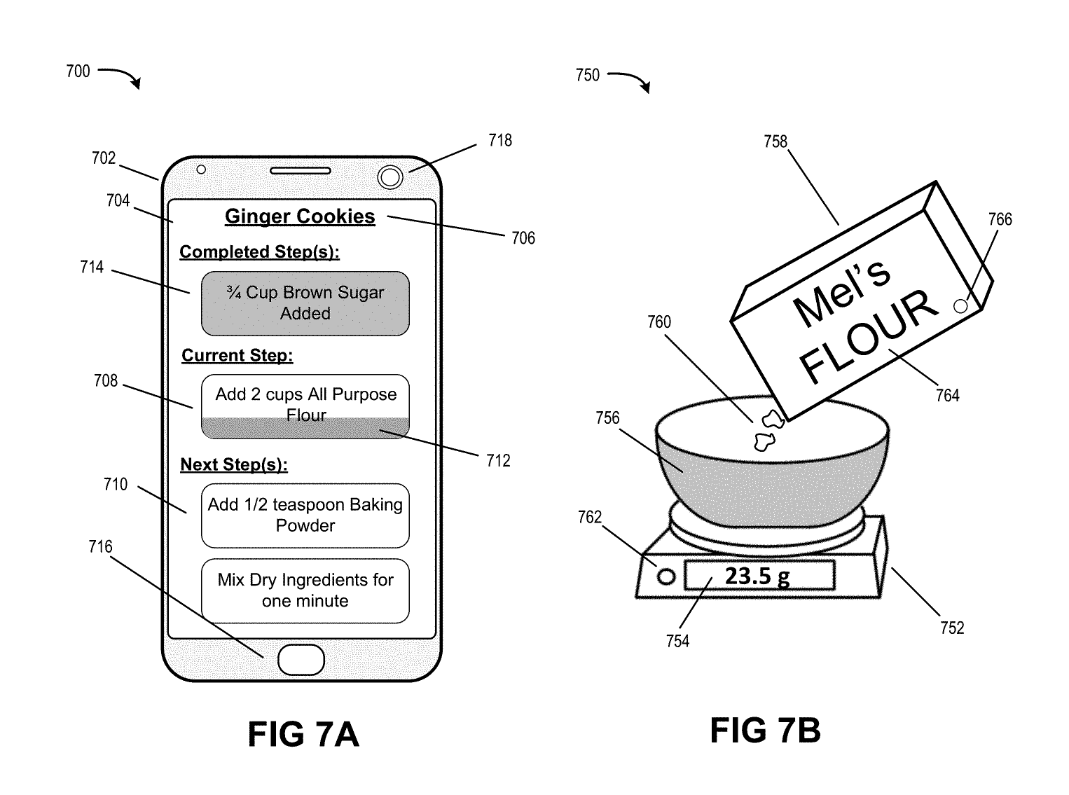

FIGS. 7A and 7B are example illustrations 700 and 750 of a user computing device and an appliance configured to capture verification data to corroborate consumption events. While the user computing device and the appliance are depicted as being separate entities, a person having ordinary skill would understand that in some embodiments one or more of the components described as being a part of user computing device and the appliance may be integrated into a single device.

FIG. 7A illustrates an exemplary environment 700 for guiding a user 104 through the completion of a recipe. FIG. 7A depicts a user computing device 702 presenting a recipe interface on a display 704. FIG. 7A depicts user computing device 702 as a smartphone, but in different embodiments the user computing device 702 may be any type of computing device (e.g., tablet, personal computer, laptop, voice controlled computing device, server system, etc.) able to present an interface, or cause the presentation of a recipe interface to occur on a display on a separate device.

The recipe interface may present a recipe 706. In some embodiments, the recipe interface may present one or more steps 708 and 710. The steps may correspond to instructions to add ingredients and/or perform actions during the course of making the recipe.

The recipe interface may include a current step 708 that the user 104 is to perform. In some embodiments, the user computing device 702 may be configured to receive verification data from an appliance associated with the current step 708. For example, when the current step 708 corresponds to an ingredient to be added, the user computing device 702 may receive verification data from a scale that indicates a change in the mass of a container indicative of an ingredient being added to the container. In some embodiments, the current step 708 may be presented as an unfilled block, and as the user computing device 702 receives verification data indicative of such a change in mass, the user computing device 702 may present an animation effect 712 where the empty block is filled in accordance with the verification data. For example, if the current step calls for the user to add 2 cups of all-purpose flour, and the verification data indicates a change in mass corresponding to 1 cup of flour being added (i.e. approximately 120 grams), then the animation effect 712 may cause the block to be presented as half filled. In another example, where a step may be to mix ingredients for a period of time, when the user computing device receives verification data indicative of an electric mixer being started, the user computing device 702 may present a timer or animation to assist the user 104 in mixing for the correct amount of time. The user computing device 702 may also include one or more sensors 714 and 716 for detecting audio and visual inputs. The user computing device 702 may also be configured to receive inputs via a physical interface (e.g., buttons, keyboard, etc.) and/or the display (i.e., via a touchscreen).

FIG. 7B illustrates an exemplary environment 750 where an appliance detects information indicative of the completion of an ingredient step, and transmits verification information to corroborate the completion of the ingredient step. FIG. 7B depicts an appliance 752 having a display 754. FIG. 7B depicts appliance 752 as a scale, but in other embodiments the appliance may be an oven, blender, mixer, refrigerator, food thermometer, another type of tool used to store and/or prepare food or drinks, or a combination thereof.

FIG. 7B further depicts a container 756 placed atop the scale and an ingredient 758, where a portion of the ingredient 760 is being added to the container 756. As the portion of the ingredient 760 is added to the container 756, the appliance 752 is able to detect a change in mass of the container 756, and may transmit verification data 116 indicating the change of mass. In this way, an entity receiving the verification data 116 can corroborate that addition of the ingredient occurred using physical evidence that the ingredient was added. Additionally, the receiving entity can also generate consumption data that reflects the actual amount of the ingredient that was actually added by a user 104.

In some embodiments, appliance 752 may include a sensor 762 to capture brand information 764 for the ingredient 758. For example, the sensor may be a camera configured to capture an image of the ingredient. The verification data may include the captured image, or may include one or more characteristics (e.g., packaging, dimensions, colors, brand, labels, etc.) that are determined from the image. The sensor 762 may be configured to capture information included, conveyed, or otherwise associated with a tag 766 located on ingredient 758. Tag 766 may be a visual tag (e.g., a barcode, QR code, etc.) or another type of tag configured to identify an ingredient or otherwise convey information associated with the ingredient (e.g., RFID, embedded chip, etc.).

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An electronic consumption tracking device comprising:
one or more processing units; and
memory storing computer-executable instructions executable by the one or more processing units to perform operations comprising;
receiving, from an appliance, first sensor information associated with a first consumption event involving a food item;
determining, based on the first sensor information, first food item data associated with the first consumption event;
generating, based on the first food item data, a consumption profile associated with the food item, wherein the consumption profile indicates that the first food item data is associated with the first consumption event;
receiving, from the appliance, second sensor information associated with a second consumption event involving the food item;
determining, based on the second sensor information, second food item data associated with the second consumption event;
updating, based on the second food item data, the consumption profile so that the consumption profile indicates both (i) the first food data associated with the first consumption event and (ii) the second food item data associated with the second consumption event.

2. The electronic consumption tracking device as recited in claim 1, wherein the appliance is an electronic cooking scale, and the first sensor information corresponds to a change of mass detected by the electronic cooking scale.

3. The electronic consumption tracking device as recited in claim 1, wherein the first food item data comprises one or more of:
an amount of the food item that was consumed by the first consumption event;
a time associated with the first consumption event;
a date of the first consumption event; and
a recipe associated with the first consumption event.

4. The electronic consumption tracking device as recited in claim 1, wherein generating the consumption profile for the food item comprises:
determining, by the electronic consumption tracking device, that the electronic consumption tracking device does not have access to a previously generated consumption profile for the food item; and
based on the electronic consumption tracking device not having access to the previously generated consumption profile, performing at least one of:
generating a new data file associated with the consumption profile of the food item; and
generating, within a database accessible to the electronic consumption tracking device, a new data entry corresponding to the consumption profile of the food item.

5. The electronic consumption tracking device as recited in claim 1, the operations further comprising:
determining, based on the second food item data and the consumption profile, that the food item has been fully consumed; and
updating the consumption profile to indicate that the food item has been fully consumed.

6. The electronic consumption tracking device as recited in claim 1, further comprising determining, based on the first food item data and the second food item data, an estimated date that the food item will be fully consumed.

7. The electronic consumption tracking device as recited in claim 1, the operations further comprising:
receiving third sensor information associated with an additional food item;
determining that the third sensor information verifies a third consumption event involving a second food item;
determining, based on the third sensor information, third food item data associated with the third consumption event; and
generating an additional consumption profile associated with the second food item, wherein the additional consumption profile indicates third food data associated with the third consumption event.

8. A computer-implemented method comprising:
receiving, by an electronic consumption tracking device, sensor information associated with a food item;
determining, by the electronic consumption tracking device and based on the sensor information, food item data associated with the food item; and
generating, by the electronic consumption tracking device and based on the food item data, a consumption profile associated with the food item.

9. The computer-implemented method of claim 8 wherein the sensor information comprises sensor data generated by a sensor associated with an appliance, the method further comprising:
determining that the sensor data verifies an occurrence of a consumption event associated with the food item is being consumed;
determining, by the electronic consumption tracking device and based on the sensor information, a first quantity of the food item has been consumed in associated with the consumption event; and
updating, by the electronic consumption tracking device and based on the first quantity, the consumption profile to indicate that the first quantity of the food item was consumed in association with the consumption event.

10. The computer-implemented method of claim 9, wherein the consumption event comprises one or more of:
a quantity of the food item being used to make a recipe;
the quantity of the food item being added to a container; or
the quantity of the food item being eaten.

11. The computer-implemented method of claim 9, further comprising:
determining, by the electronic consumption tracking device and based on the consumption profile, that a second quantity of the food item remaining is at or below a threshold value; and
presenting, on a display associated with the electronic consumption tracking device, an option for obtaining the food item.

12. The computer-implemented method of claim 8, wherein the sensor information comprises a scan of a receipt, determining the food item data comprises determining that the scan of the receipt indicates that the food item was obtained, and generating the consumption profile comprises determining that the electronic consumption tracking device does not have access to a previously generated consumption profile for the food item.

13. The computer-implemented method of claim 8, wherein the sensor information comprises a change of mass detected by an electronic cooking scale.

14. The computer-implemented method of claim 8, wherein the consumption profile indicates one or more of:
an identifier for the food item;
a consumption event associated with the food item being consumed;
an amount of the food item consumed in association with the consumption event;
a recipe associated with the consumption event; or
a date associated with the consumption event.

15. A non-transitory computer-readable storage medium having thereon at set of instructions, which if performed by a computer, cause the computer to at least:
receive sensor information associated with a food item;
determine that the sensor information verifies a consumption event associated with a first quantity of the food item being consumed; and
generate a consumption profile associated with the food item, wherein the consumption profile indicates that the first quantity of the food item was consumed in association with the consumption event.

16. The non-transitory computer-readable storage medium as recited in claim 15, wherein the sensor information associated with the food item is first sensor information associated with a first food item, and the instructions further cause the computer to:
receive second sensor information associated with a second food item;
determine that the second sensor information verifies an additional consumption event associated with a second quantity of the second food item being consumed; and
generate an additional consumption profile associated with the second food item, wherein the additional consumption profile indicates that the second quantity of the second food item was consumed in association with the additional consumption event.

17. The non-transitory computer-readable storage medium as recited in claim 16, wherein the second sensor information is received from an electronic blender, and the second sensor information corresponds to change of mass detected by a sensor component of the electronic blender

18. The non-transitory computer-readable storage medium as recited in claim 15, wherein the sensor information is first sensor information, and the instructions further cause the computer to:
receive second sensor information associated with the food item;
determine that the sensor information verifies an additional consumption event associated with a second quantity of the food item being consumed; and
update the consumption profile to indicate that (i) the first quantity of the food item was consumed in association with the consumption event, and (ii) the second quantity of the food item was consumed in association with the additional consumption event.

19. The non-transitory computer-readable storage medium as recited in claim 18, wherein the second sensor information is received from a scale, and the second sensor information corresponds to change of mass detected by the electronic cooking scale.

20. The non-transitory computer-readable storage medium recited in claim 18, wherein the instructions further cause the computer to determine, based on the consumption profile, an estimated date that the food item will be fully consumed.
